(19) United States
(12) Patent Application Publication
(10) Pub. No.: US 2006/0149398 A1
(43) Pub. Date: Jul. 6, 2006

(54) Content capturing device

(76) Inventors: Katsuhiro Sato, Aichi (JP); Toru Kamimura, Shiga (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/545,803

(22) PCT Filed: Feb. 12, 2004
(86) PCT No.: PCT/JP04/01517

§ 371 Date: Aug. 16, 2005

(30) Foreign Application Priority Data
Feb. 17, 2003 (JP) 2003037643

(51) Int. Cl. G06F 17/00

(52) U.S. Cl. 700/94

(57) ABSTRACT

A content capturing device applies to a music reproducing device. The music reproducing device has a function as an Internet radio receiver of receiving via the Internet a program provided from a radio server at a broadcast station. When a predetermined operation is performed while an arbitrary piece of music is being received by means of this function, the radio server sends music information related to the music being received and according to the operating environment of the music reproducing device, to the music reproducing device. When an operation of making a request for downloading is performed by the music reproducing device, data for storage according to the music information is downloaded from the music distribution server to the music reproducing device. Therefore, it is possible to download the data for storage on a desired piece of music to the music reproducing device in an easy manner and in a form according to the operating environment of the music reproducing device.

### TECHNICAL FIELD

The present invention relates to a content capturing device. More specifically, the present invention relates to a content capturing device that has a function of reproducing in real time a content signal received from a sending source.

### PRIOR ART

A conventional example of this kind of apparatus is disclosed in Japanese Patent Laid-open No. 2002-318587. According to the prior art, music data broadcast from a broadcast station is received by a music data receiver and is reproduced in real time. The music data includes music-related information for identifying the music data. When a predetermined instruction is given by a user of the music data receiver, the music data receiver is connected to a music distribution server based on the music-related information. Then, a distribution request containing the music-related information is sent from the music data receiver to the music distribution server. In response to that, the music data identified by the music-related information is downloaded from the music distribution server to the music data receiver. Therefore, the user can easily download the music data even though he has no knowledge about the music being broadcast such as the title of the music.

Incidentally, such data to be downloaded as mentioned above is generally provided in a compressed state. In addition, there exist various modes for compressing data. Meanwhile, with the above mentioned prior art, the music data (music) itself to be downloaded is uniquely identified according to the music-related information, but its compression mode is not identified, that is, it is limited to a certain compression mode. Therefore, in a unit as a download destination (music data receiver), it is necessary to provide an environment for decompressing the data compressed in the certain compression mode. Thus, there is a problem where the downloaded data could not be reproduced without such an environment.

### SUMMARY OF THE INVENTION

Therefore, it is a primary object of the present invention to provide a novel content capturing device.

It is another object of the present invention to provide a content capturing device which can capture a desired content signal in an easy manner and in a form according to its operating environment.

The present invention is a content capturing device having a function of reproducing in real time a first content signal received from a first sending source, comprising a holding means for holding operating environment information, an acquiring means for acquiring content information corresponding to the first content signal and according to the operating environment information from the first sending source, and a capturing means for capturing a second content for storage from a second sending source based on the content information.

In the present invention, the holding means holds the operating environment information indicative of the operating environment of the content capturing device itself. Then, while the first content signal received from the first sending source is being reproduced in real time, the acquiring means acquires from the first sending source the content information corresponding to the first content signal being reproduced and according to the operating environment information. Then, based on the content signal, the capturing means captures from the second sending source the second content signal for storage, more specifically, the content signal corresponding to the first content signal and according to the operating environment of the content capturing device itself.

Additionally, the acquiring means may include a requesting means for issuing a request to the first sending source for acquisition of the content information and a receiving means for receiving the content information sent from the first sending source in response to the request made by the requesting means.

In this case, the requesting means may deliver the operating environment information in making a request to the first sending source for acquisition of the content information.

In one embodiment of the present invention, the second content signal is a compressed signal. The second content signal which is compressed is decompressed by a decompressing means. Also, the operating environment information includes compression mode information on compression modes supported by the decompressing means.

In another embodiment of the present invention, the operating environment information includes language information indicative of a specific language. Thus, at least a part of the content information is output in the specific language from an information output means.

In still another embodiment of the present invention, a setting means arbitrarily sets the operating environment information.

Besides, the first content signal includes an audio signal for radio broadcasting.

According to the present invention, based on the content information acquired from the first sending source, captured is the second content signal for storage corresponding to the first content signal under reproduction and according to the operating environment of the content capturing device itself. That is, it is possible to capture the desired content signal in an easy manner and in a form according to the operating environment of the content capturing device itself.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a schematic structure of one embodiment of the present invention;

FIG. 2 is a block diagram showing a schematic structure of a music reproducing device shown in FIG. 1;

FIG. 3 is an illustrative view showing a flow of operation of an entire system during the time when downloading is done by means of the quick download function of the music reproducing device in the FIG. 1 embodiment;

FIG. 4 is an illustrative view showing one example of information window displayed on a liquid crystal display shown in FIG. 2;

FIG. 5 is an illustrative view showing a conceptual structure of operating environment information sent from the music reproducing device to a radio server in the FIG. 1 embodiment;

FIG. 6 is an illustrative view showing conceptual recorded contents of a management database within the radio server shown in FIG. 1;

FIG. 7 is an illustrative view showing a conceptual structure of music information sent from the radio server to the music reproducing device in the FIG. 1 embodiment;

FIG. 8 is an illustrative view showing conceptual recorded contents of a management list shown in FIG. 2;

FIG. 9 is an illustrative view showing one example of a download acceptance window displayed on the liquid crystal display shown in FIG. 2;

FIG. 10 is an illustrative view showing conceptual recorded contents of a music database within a music distribution server shown in FIG. 1;

FIG. 11 is an illustrative view showing one example of a message window displayed on the liquid crystal display shown in FIG. 2;

FIG. 12 is an illustrative view showing a message window different from that shown in FIG. 11;

FIG. 13 is an illustrative view showing a message window still different from that shown in FIG. 12;

FIG. 14 is an illustrative view showing a message window further different from that shown in FIG. 15;

FIG. 15 is an illustrative view showing a flow of operation of the entire system during the time when downloading is done by means of the after download function of the music reproducing device in the FIG. 1 embodiment;

FIG. 16 is an illustrative view showing one example of a top window displayed on the liquid crystal display shown in FIG. 2;

FIG. 17 is an illustrative view showing a download acceptance window different from that shown in FIG. 9;

FIG. 18 is an illustrative view showing a flow of operation of the entire system during the time when downloading is done in a pattern different from that shown in FIG. 15;

FIG. 19 is an illustrative view showing a message window still different from that shown in FIG. 14;

FIG. 20 is an illustrative view showing a message window further different from that shown in FIG. 19;

FIG. 21 is a flowchart showing the operation of a main CPU during the time when an α broadcast station is selected by the music reproducing device in the FIG. 1 embodiment;

FIG. 22 is a flowchart continued from FIG. 21;

FIG. 23 is a flowchart continued from FIG. 22;

FIG. 24 is a flowchart showing the operation of the main CPU during the time when the after download function of the music reproducing device is enabled in the FIG. 1 embodiment;

FIG. 25 is a flowchart continued from FIG. 24;

FIG. 26 is a flowchart continued from FIG. 25;

FIG. 27 is a flowchart showing the operation of the radio server that is accessed by the music reproducing device in the FIG. 1 embodiment; and

FIG. 28 is a flowchart showing the operation of the music distribution server that is accessed by the music reproducing device in the FIG. 1 embodiment.

### BEST MODE FOR PRACTICING THE INVENTION

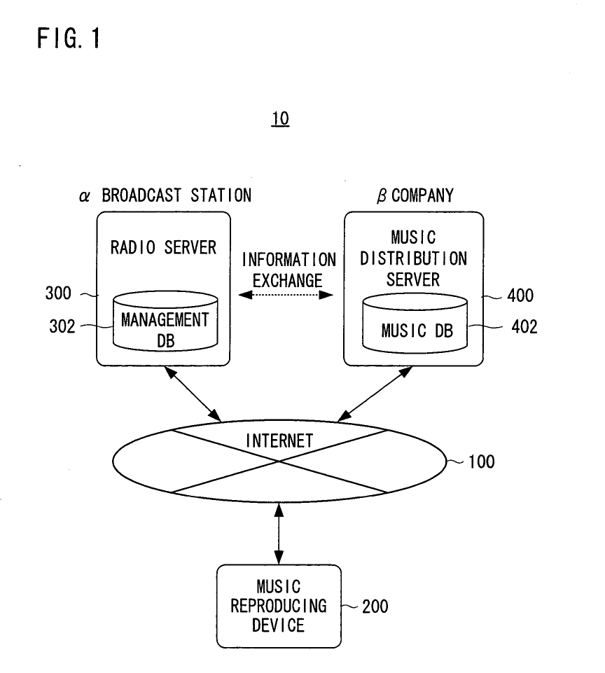

Referring to FIG. 1, a music distribution system 10 of this embodiment includes a music reproducing device 200 capable of being connected to the Internet 100, a radio server 300 for providing via the Internet 100 the same program as that broadcast on radio, and a music distribution server 400 for distributing music data via the Internet 100.

The music reproducing device 200 is a home appliance having the function of receiving a program provided from the radio server 300, as a so-called Internet radio receiver.

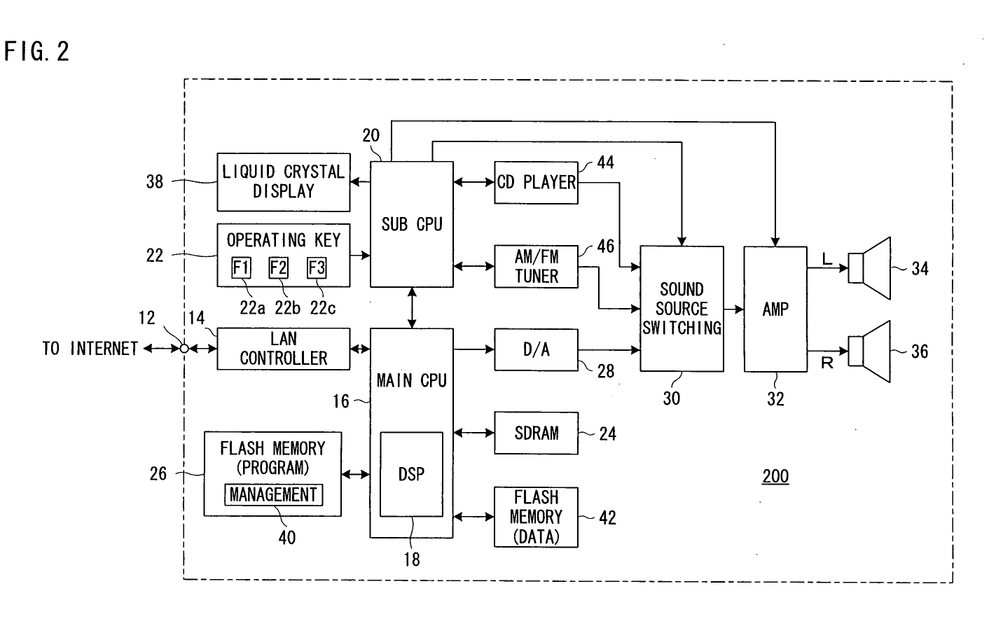

More specifically, the music reproducing device 200 has a communication connector 12 constituting a physical port to connect with the Internet 100, as shown in FIG. 2. That is, the communication connector 12 is connected to a not illustrated modem (for example, an ADSL (Asymmetric Digital Subscriber Line) modem) via a not illustrated LAN (Local Area Network) cable, and thus is connected to a telephone line. Meanwhile, in the music reproducing device 200, the communication connector 12 is connected to a main CPU (Central Processing Unit) 16 via a LAN controller 14 ready for Ethernet (registered trademark). Also, the main CPU 16 is formed by ASIC (Application Specified IC) integrally with a DSP (Digital Signal Processor) 18 described later. Besides, in addition to the main CPU 16, a sub CPU 20 for controlling a man-machine interface is provided within the music reproducing device 200.

When an operation of accessing the radio server 300 at an arbitrary broadcast station, that is, a selecting operation is carried out by an operating key 22, the sub CPU 20 notifies the main CPU 16 of the details of the operation. Based on the notification from the sub CPU 20, the main CPU 16 generates a packet signal for making an access request to the radio server 300, according to TCP/IP (Transmission Control Protocol/Internet Protocol). The generated packet signal is sent to the Internet 100 via the LAN controller 14 and the communication connector 12, and is delivered to the radio server 300 through a predetermined route. That is, the packet signal is routed to the radio server 300.

The radio server 300 recognizes the access request from the music reproducing device 200 by receiving the above mentioned packet signal. Then, in response to the access request, it turns streaming data indicative of the contents of the program into packet signals according to TCP/IP, and then sends them to the music reproducing device 200.

The packet signals sent from the radio server 300 to the music reproducing device 200 are input in sequence to the main CPU 16 via the communication connector 12 and the LAN controller 14. The main CPU 16 retrieves the above mentioned streaming data from the input packet signals, and temporarily stores the retrieved streaming data in an SDRAM (Synchronous Dynamic RAM) 24 as a main memory. Then, it transfers the streaming data stored in the SDRAM 24 to the DSP 18.

The streaming data transferred to the DSP 18 is data compressed in WMA (Windows Media Audio: Windows is a registered trademark) mode, for example. The DSP 18 decodes the compressed streaming data to reproduce pre-compression PCM (Pulse Code Modulation) data. A decoding program for decoding data thus compressed in WMA mode is stored in a flash memory 26. The flash memory 26 also stores a decoding program for decoding data compressed in MP3 (MPEG-1/Audio Layer3) mode. That is, the DSP 18 functions as a decoder supporting two audio compression modes, WMA mode and MP3 mode.

The PCM data reproduced by the DSP 18 is input into a D/A conversion circuit 28 and converted there into an audio signal as an analog electric signal. The converted audio signal is input to an amplifying circuit 32 via a sound source switching circuit 30, subjected to an amplifying process, and then input into each of right and left speakers 34 and 36. This allows the speaker 34 and 36 to output the sounds of the program in real time.

In addition to the function of an Internet radio receiver, the music reproducing device 200 has a download function of downloading music data for storage from the music distribution server 400. The download function includes two features: a quick download function and an after download function.

One of them, the quick download function is enabled while the device works as the above mentioned Internet radio receiver and receives a program from a specific broadcast station (the α broadcast station in this embodiment). According to the quick download function, when a predetermined operation is performed by means of the operating key 22 while an arbitrary music is broadcast at a program from the α broadcast station, data for storage on the music is promptly downloaded from the music distribution server 400. Also, the data for storage is provided in a compression mode that can be decoded by the music reproducing device 200 (DSP 18), i.e. in WMA mode or MP3 mode.

Moreover, prior to downloading of the data for storage, information related to the data for storage, for example, information such as the title of the music and the name of the performer is acquired from the radio server 300 at the α broadcast station. Then, the acquired information is displayed on the liquid crystal display 38 in a language according to local information described later.

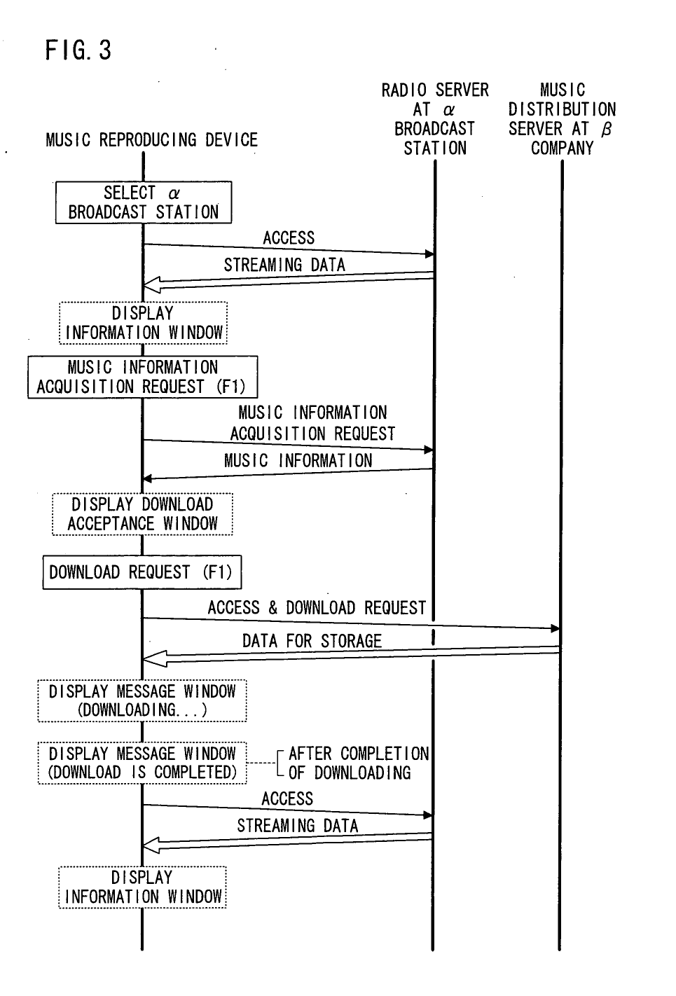

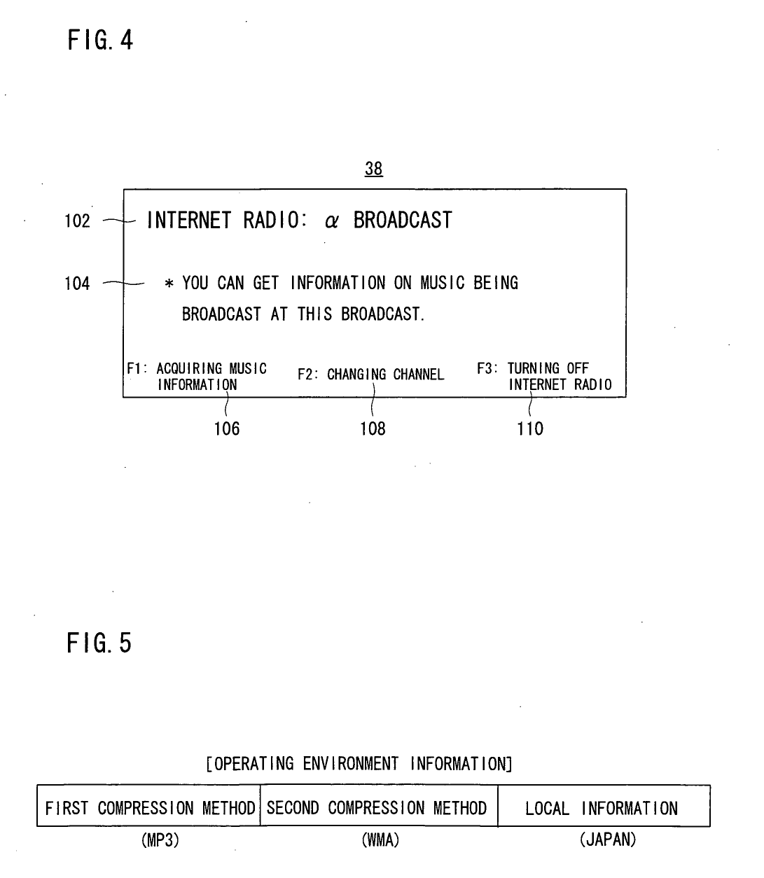

More specifically, if an operation of selecting the α broadcast station is now performed on the music reproducing device 200 as shown in FIG. 3, for example, then the music reproducing device 200 makes an access request to the radio server 300 at the a broadcast station in the above described manner. In response to the access request, the radio server 300 at the α broadcast station sends streaming data (packet signals) of the program to the music reproducing device 200. As a result, the sounds of the program are output from the speakers 34 and 36 of the music reproducing device 200. In addition, the liquid crystal display 3 8 displays an information window shown in FIG. 4. Incidentally, display of the liquid crystal display 38 is controlled by the sub CPU 20. The sub CPU 20 controls display of the liquid crystal display 38 under instructions from the main CPU 16.

Displayed in an upper part of the information window shown in FIG. 4 is a horizontally written character string 102 indicating that the music reproducing device 200 functions as an Internet radio receiver and that the α broadcast station is currently selected. Also, displayed under the character string 102 is a horizontally written character string 104 indicating that it is possible to acquire information on the music being received. Moreover, displayed in a horizontal row under the character string 104 are horizontally written character strings 106, 108 and 110 indicative of the respective functions of an F1 key 22a, F2 key 22b and F3 key 22c constituting the operating key 22.

When the F2 key 22b is pressed here, the music reproducing device 200 (main CPU 16) makes an access request to the radio server 300 at another broadcast station in order to select that broadcast station. On the other hand, when the F3 key 22c is pressed, the music reproducing device 200 disables its function as an Internet radio receiver, and terminates the connection to the Internet 100.

Also, when the F1 key 22a is pressed while an arbitrary music is broadcast at a program being received (from the α broadcast station), the music reproducing device 200 issues a music information acquisition request to the radio server 300 at the α broadcast station in order to obtain information on the arbitrary music. At the same time, the music reproducing device 200 also sends operating environment information shown in FIG. 5 to the radio server 300 at the α broadcast station. In addition, these music information acquisition request and operating environment information are delivered by packet signals according to the above mentioned TCP/IP, from the music reproducing device 200 to the radio server 300 at the α broadcast station.

Referring to FIG. 5, the operating environment information includes information on a first compression mode and a second compression mode and the above mentioned local information. Among them, the first compression mode and the second compression mode means compression modes which allows decoding by the music reproducing device 200 (DSP 18). FIG. 5 presents a state where “MP3 mode” is set as the first compression mode and “WMA mode” is set as the second compression mode. Which compression mode, “MP3 mode” or “WMA mode”, to be set as the first compression mode or second compression mode can be arbitrarily selected by means of the operating key 22. Additionally, the local information indicates the country in which the music reproducing device 200 is to be used, in other words, the nationality of a user of the music reproducing device 200. FIG. 5 indicates a state where the local information is set to “Japan”. The local information can also be arbitrarily set by manipulating the operating key 22. Incidentally, a program for setting arbitrary operating environment information is stored in the above mentioned flash memory 26. Also, the set operating environment information is stored as well in the flash memory 26. No special description is provided here as to a procedure for setting the operating environment information and the details of its process.

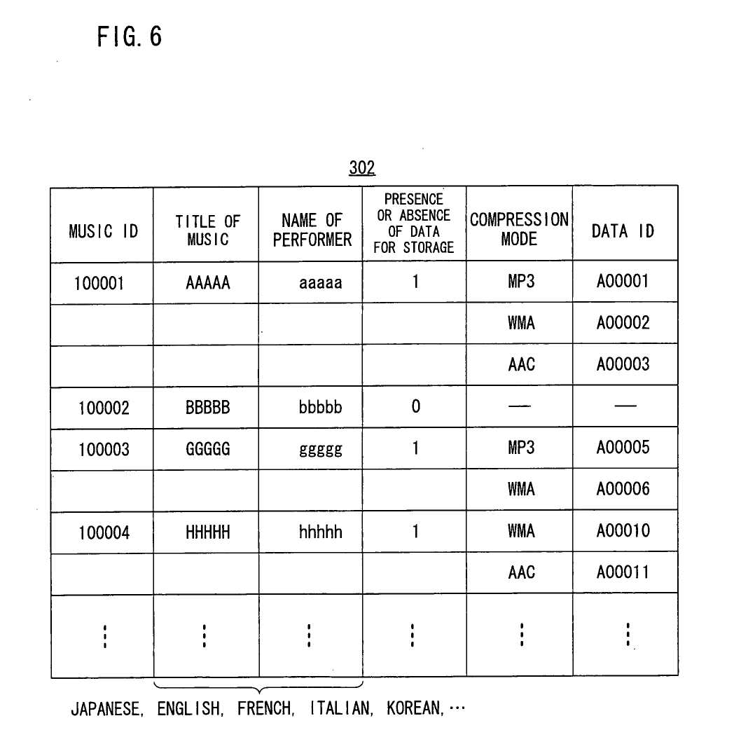

Meanwhile, the radio server 300 at the α broadcast station has a management database 302 which records various kinds of information on pieces of music broadcast at its programs (including the ones already broadcast and the ones to be broadcast in the future). Specifically, as shown in FIG. 6, the management database 302 records a music ID given to each piece of music, the title of the music, the name of the performer, information indicative of whether the music data for storage is prepared or not in the music distribution server 400, and if the data for storage is prepared, the compression mode and the data ID given to each of the data for storage.

More specifically, a piece of music titled “AAAAA” sang (or played) by a performer named “aaaaa”, for example, is given a unique music ID “100001”. Also, for the music, the data for storage is prepared in the music distribution server 400. The data for storage is available in three kinds of data compressed in “MP3 mode”, “WMA mode” and “ACC (Advanced Audio Coding) mode”, respectively. Moreover, the management database 302 records that these three kinds of data for storage are given individual data IDs, “A00001”, “A00002” and “A0003”, respectively. In addition, according to the management database 302, a piece of music titled “BBBBB” sang by a performer named “bbbbb” is given a management ID “100002”. Since “0” is recorded in the section indicative of the presence or absence of data for storage, it can be found that no data for storage is prepared. Incidentally, the title of the music and the name of the performer are recorded in a plurality of forms according to a plurality of languages including Japanese, English, French, Italian, Korean (Hangul), etc.

Upon reception of the above mentioned music information acquisition request issued from the music reproducing device 200, the radio server 300 at the α broadcast station identifies information on the music being broadcast, more specifically, the music ID, the title of the music, the name of the performer and the presence or absence of data for storage, from the management database 302. Furthermore, if it has determined that there exists the data for storage (if “1” is recorded in the section indicative of the presence or absence of data for storage), then it determines whether or not there exists, in the prepared data for storage, data compressed in a mode corresponding to the first compression mode contained in the above mentioned operating environment information, i.e., the MP3 mode. If such data exists, the data ID for the data is identified. Besides, if there is no data for storage compressed in the MP3 mode, it determines whether or not there exists data for storage compressed in the WMA mode as the second compression mode. If such data exists, the data ID for the data is identified.

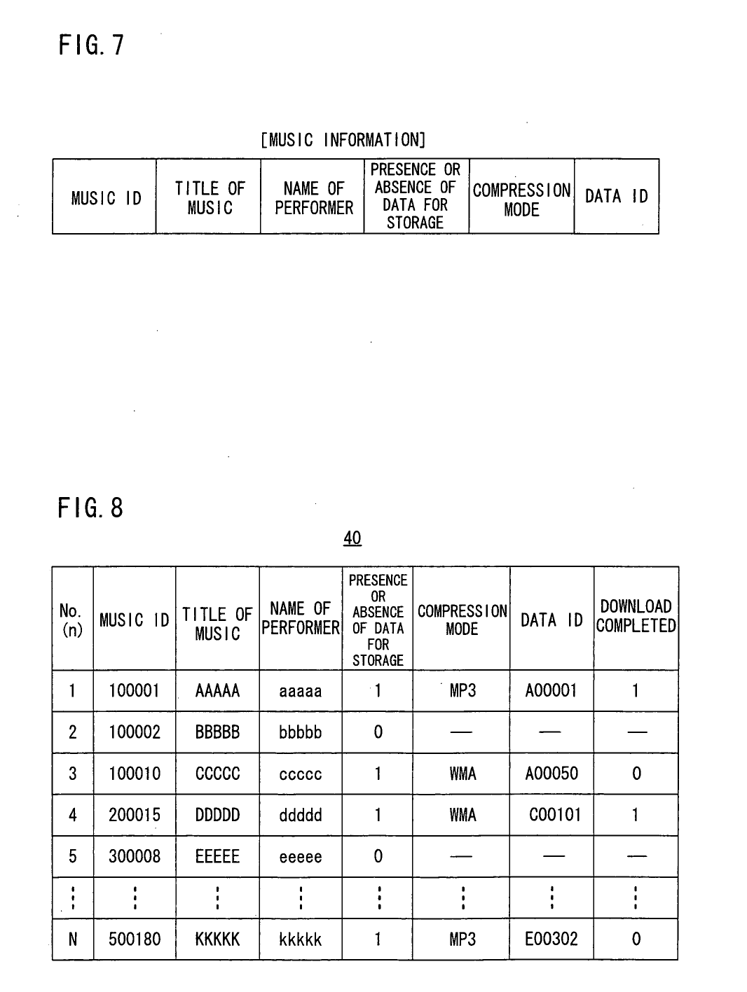

As stated above, after identifying the music ID of the music being broadcast, the title of the music, the name of the performer, the presence or absence of data for storage, and the compression mode and the data ID if there is data for storage, the radio server 300 at the α broadcast station compiles these kinds of identified data into music information as shown in FIG. 7. Then, it sends the music information to the music reproducing device 200 as an accessing source, as shown in FIG. 3. The music information is also formed into packet signals according to TCP/IP and then transmitted.

Besides, among the music information as shown in FIG. 7, the sections for the title of the music and the name of the performer are provided with information for expressing them in a language corresponding to the local information contained in the above operating environment information. That is, in this embodiment, the local information is set to “Japan” and thus the sections for the title of the music and the name of the performer are provided with JIS codes for expressing them in Japanese. Also, if it is determined that there is no data for storage on the music being broadcast, “0” is set to the section for the presence or absence of data for storage out of the music information, and blanks are left in the sections for the compression mode and the data ID. In addition, if it is determined that there exists data for storage but the data is not compressed in the first compression mode (MP3 mode) or the second compression mode (WMA mode), then “0” is set to the section for the presence or absence of data for storage and blanks are left in the sections for the compression mode and the data ID, as in the case where it is determined that there exists no data for storage.

The music information is received by the music reproducing device 200, and more specifically, it is input into the main CPU 16 via the communication connector 12 and the LAN controller 14. The main CPU 16 records the input music information to a management list 40 in the flash memory 26.

Referring to FIG. 8, the music information to be recorded on the management list 40 is each given a serial number “n” in recorded order. That is, the music information acquired on a later turn from the radio server 300 at the α broadcast station is given a larger serial number “n”. The management list 40 is also provided with a section that indicates whether the data for storage on each piece of music is downloaded or not (the section on right end in FIG. 8), and “0” is recorded as an initial value in the section for the music information immediately after acquisition, i.e., the section for the music information with a serial number “N”.

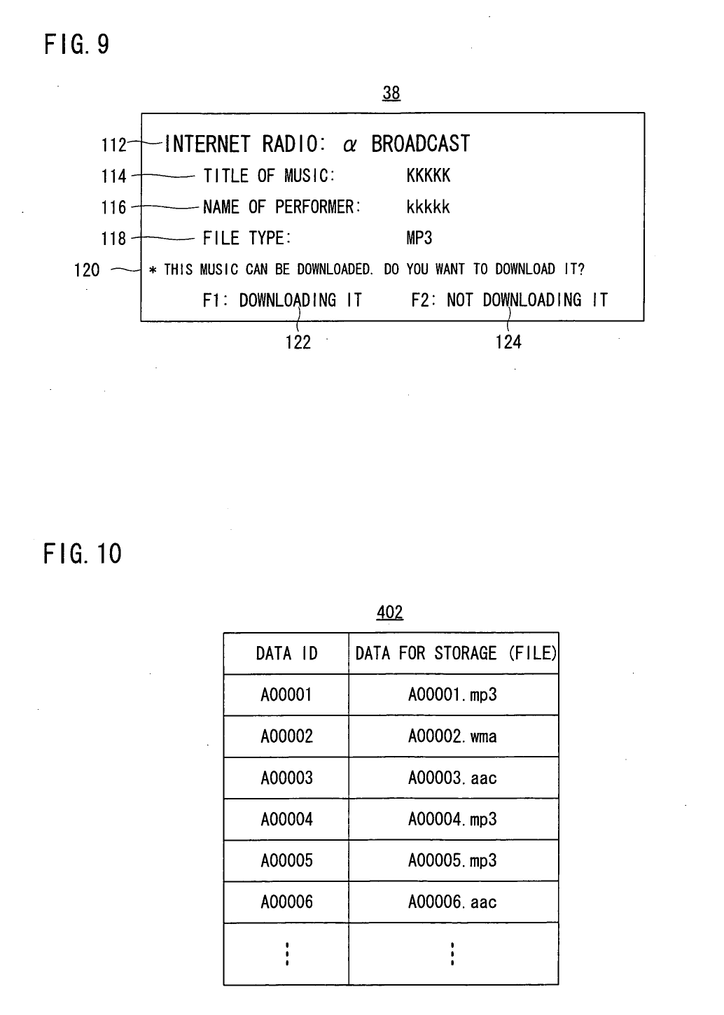

It is here assumed that the title of the music being currently broadcast is “KKKKK” and that the name of the performer is “kkkkk”, as shown in the above mentioned music information with the serial number “N”. Also, it is assumed that the data for storage on the music compressed in “MP3 mode” is prepared in the music distribution server 400. In this case, the liquid crystal display 38 displays a download acceptance window as shown in FIG. 9.

Displayed in an upper part of the download acceptance window is a character string 112 similar to the character string 102 in the above mentioned information window of FIG. 4. Also, displayed under the character string 112 are horizontally written character strings 114, 116 and 118 in a vertical row that indicate the title of the music being currently broadcast, the name of the performer and the compression mode (file format) of the data for storage, respectively. Moreover, under the character string 118 is a horizontally written character string 120 for showing that it is possible to download the data for storage on the music indicated by the character strings 114 to 118 and making an inquiry about whether or not to download the data for storage. In addition, displayed under the character string 120 are horizontally written character strings 122 and 124 in a horizontal row that indicate the functions of the F1 key 22a and F2 key 22b, respectively.

When the F2 key 22b is pressed here, display of the liquid crystal display 38 returns to the information window shown in FIG. 4. On the other hand, when the F1 key 22a is pressed, the music reproducing device 200 (main CPU 16) stops access to the radio server 300 at the α broadcast station and makes an access request to the music distribution server 400 as shown in FIG. 3. Additionally, following the access request, the music reproducing device 200 requests the music distribution server 400 for downloading of the data for storage indicated by the data ID corresponding to the serial number “N” (“E00302” in this embodiment). Besides, the access request and download request from the music reproducing device 200 to the music distribution server 400 are also delivered by packet signals according to TCP/IP.

The music distribution server 400 is managed by β company in a business alliance with the α broadcast station, and has a music database 402 that records data for storage of music broadcast at a program from the α broadcast station. More specifically, as shown in FIG. 10, the music database 402 records the data for storage (files) on individual pieces of music by the above mentioned data ID, as shown in FIG. 10. However, the music database 402 does not record the data for storage on all the pieces of music broadcast at the program from the α broadcast station. No data for storage are prepared on some of these pieces of music, as in the case of the above mentioned music titled “BBBBB” sang by the performer named “bbbbb”. Also, even for the pieces of music on which the data for storage are prepared, some of them have only the data compressed in limited kind(s) of compression mode(s).

Information exchange is performed on a regular basis between the music distribution server 400 and the radio server 300 at the α broadcast station. Based on the information exchange, the contents of the music database 402 and management database 302 are updated in succession. That is, the radio server 300 at the α broadcast station knows at all times on what music the data for storage is prepared in the music distribution server 400.

Upon reception of a download request from the music reproducing device 200, the music distribution server 400 extracts data for storage corresponding to the specified data ID from the music database 402. Then, it transmits the extracted data for storage to the music reproducing device 200 as an accessing source, as shown in FIG. 3. Incidentally, prior to the transmission of the data for storage, the music distribution server 400 sends a start instruction for starting the transmission to the music reproducing device 200. Then, at the completion of transmission of the data for storage, the music distribution server 400 sends an end instruction to the music reproducing device 200. The data for storage, the start instruction and the end instruction are also sent in a state of being formed into packet signals according to TCP/IP.

The data for storage sent to the music reproducing device 200 is input into the main CPU 16 via the communication connector 12 and the LAN controller 14. The main CPU 16 records the input music information in a flash memory 42 for data storage different from the above stated flash memory 26. That is, it downloads the music information.

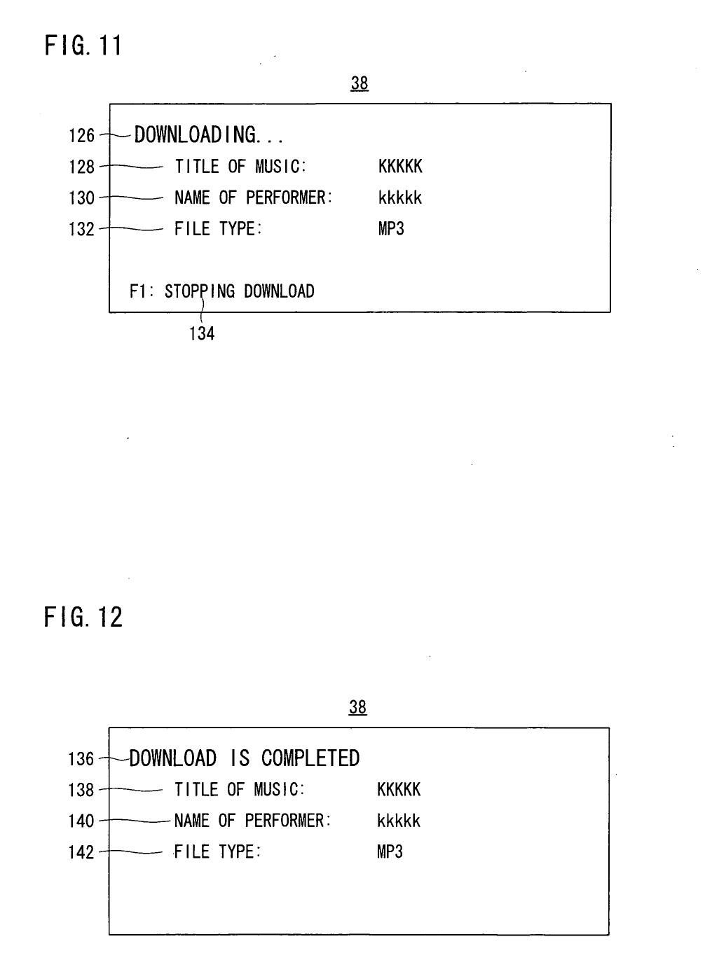

Upon reception of the above mentioned start instruction, the main CPU 16 also instructs the sub CPU 20 to display a message window shown in FIG. 11 on the liquid crystal display 38. Displayed in the upper part of the message window is a horizontally written character string 126 indicating that the music reproducing device 200 is downloading the data for storage. Also, displayed under the character string 126 are horizontally written character strings 128, 130 and 132 in a vertical row that indicate the title of the music (the data for storage) being downloaded, the name of the performer of that music and the compression mode of that music, respectively. In addition, displayed under the character string 132 is a horizontally written character string 134 indicative of the function of the F1 key 22a.

If the F1 key 22a is pressed here, the downloading is stopped. Then, display of the liquid crystal display 38 returns to the information window of FIG. 4. On the other hand, if the downloading is completed, that is, the above mentioned end instruction is received with the F1 key 22a not pressed, another message window shown in FIG. 12 is displayed on the liquid crystal display 38, instead of the message window of FIG. 11.

Displayed in the upper part of the message window of FIG. 12 is a horizontally written character string 136 indicating that the downloading is completed. Also, displayed under the character string 136 are horizontally written character strings 138, 140 and 142 in a vertical row that indicate the title of the downloaded music (data for storage), the name of the performer and the compression mode, respectively.

After the completion of the downloading of the data for storage in this manner, the music reproducing device 200 (the main CPU 16) makes an access request again to the radio server 300 at the α broadcast station as shown in FIG. 3. In response to the access request, the radio server 300 at the α broadcast station sends streaming data of the program to the music reproducing device 200. Consequently, the speakers 34 and 36 of the music reproducing device 200 output the sounds of the program. Then, display of the liquid crystal display 38 returns to the information window of FIG. 4. In addition, “1” indicative of the completion of the downloading is recorded in the download completed section corresponding to the serial number “N” within the above mentioned management list 40 of FIG. 8.

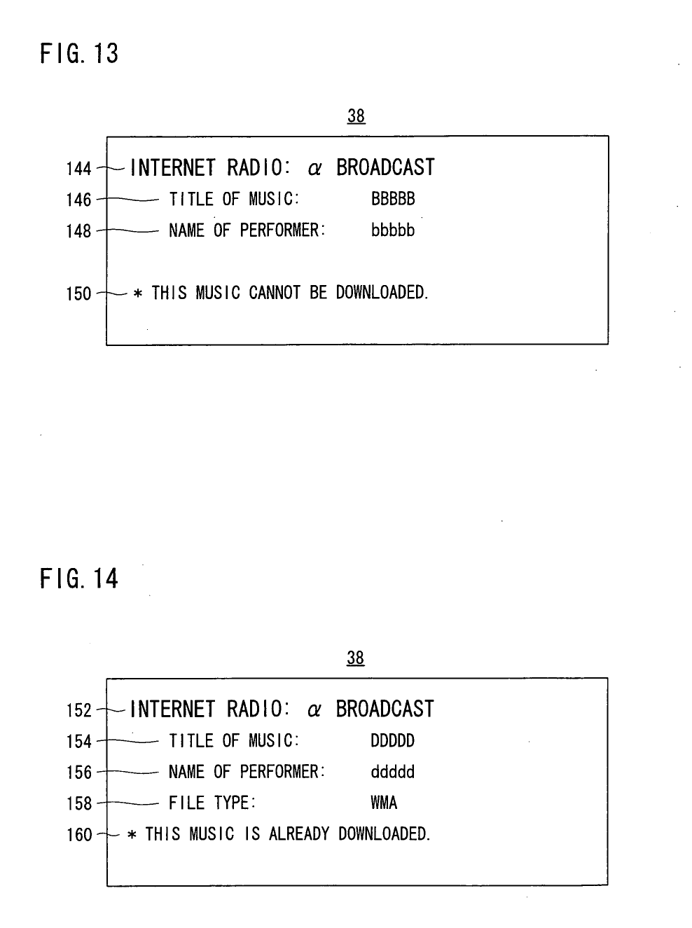

Besides, if the music information sent from the radio server 300 at the α broadcast station in response to the above stated music information acquisition request indicates that no data for storage is prepared for the music being currently broadcast, a message window as shown in FIG. 13 is displayed on the liquid crystal display 38 of the music reproducing device 200. According to the message window, displayed in its upper part is a character string 144 similar to the character string 102 in the information window of FIG. 4. Also, displayed under the character string 144 are horizontally written character strings 146 and 148 in a vertical row that indicate the title of the music being currently broadcast and the name of the performer, respectively. Moreover, displayed under the character string 148 is a horizontally written character string 150 showing that no data for storage is prepared for the music indicated by the character strings 146 and 148 (this music cannot be downloaded). This message window is displayed for a certain time (about three to five seconds), and, after that, the information window of FIG. 4 is displayed on the liquid crystal display 38.

In addition, if the data for storage on the music being currently broadcast has been downloaded before into the music reproducing device 200 and it still remains in the flash memory memory 42 (it is not erased), a message window as shown in FIG. 14 is displayed on the liquid crystal display 38. According to the message window, displayed in its upper part is a character string 152 similar to the character string 102 in the information window of FIG. 4. Also, displayed under the character string 152 is horizontally written character strings 154, 156 and 158 in a vertical row that indicate the title of the music being currently broadcast, the name of the performer and the compression mode for the data for storage, respectively. Moreover, displayed under the character string 158 is a horizontally written character string 160 showing that the data for storage on the music indicated by the character strings 154 to 158 has been already downloaded. This message window is also displayed for a certain time (about three to five seconds), and then the information window of FIG. 4 is displayed on the liquid crystal display 38.

Furthermore, if the above music acquisition request is issued while a non-music content is broadcast at the program from the α broadcast station, such as a talk of a D.J. (disc jockey) and a commercial message, the radio server 300 at the α broadcast station sends dummy music information to the music reproducing device 200. More specifically, it sends the music information in which the music ID is set to “000000” as shown in FIG. 7. In this case, no special change takes place on the part of the music reproducing device 200 and thus the information window of FIG. 4 remains displayed on the liquid crystal display.

Meanwhile, according to the after download function, in the case of the music on which the above mentioned music information is acquired but the data for storage is not yet downloaded, it is possible to download the data for storage on the music later.

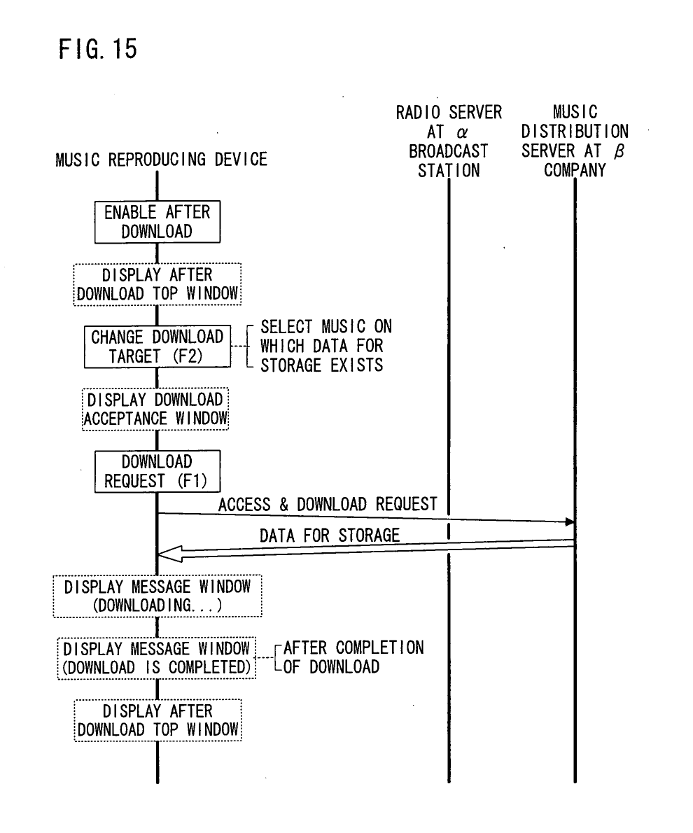

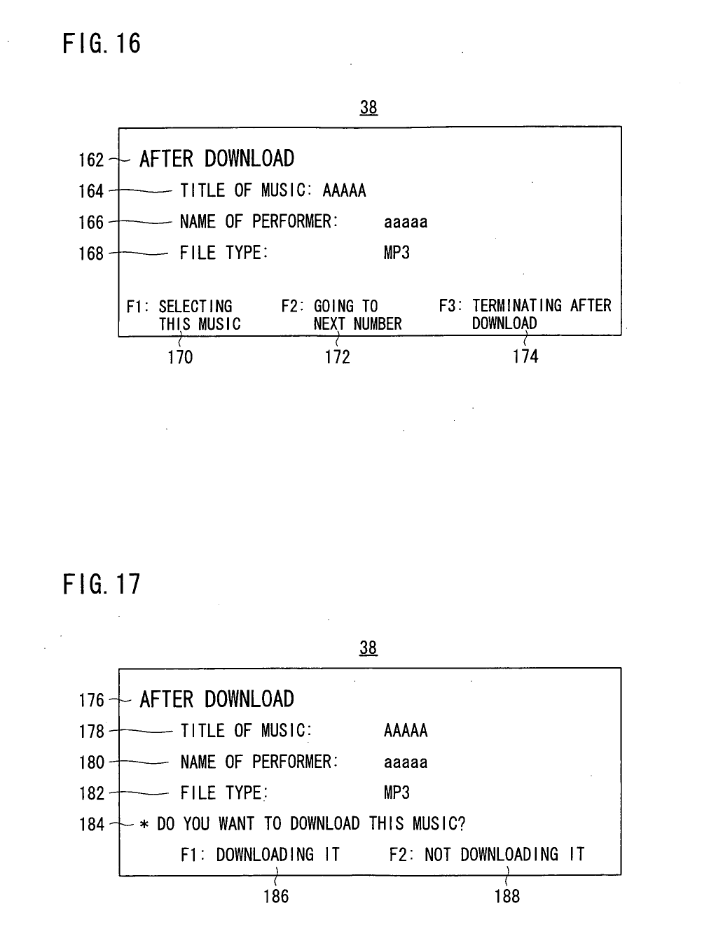

Referring to FIG. 15, if an operation of enabling the after download function is now performed on the music reproducing device 200, for example, a top window for the after download function as shown in FIG. 16 is displayed on the liquid crystal display 38.

Displayed in an information part of the top window is a horizontally written character string 162 showing that the after download function is enabled. Also, displayed under the character string 162 are horizontally character strings 164, 166 and 168 in a vertical row that indicate the title of a piece of music, the name of the performer and the compression mode of the data for storage, respectively, corresponding to one item of the music information recorded in the above stated management list 40. However, the character string 168 is displayed only if “1” is recorded in the section indicative of the presence or absence of data for storage corresponding to the music represented by the character string 164 and 166 within the management list 40. In addition, displayed under the character string 168 (or 166) are horizontally written character strings 170, 172 and 174 in a horizontal row that indicate the respective functions of the F1 key 22a, F2 key 22b and F3 key 22c.

If the F2 key 22b is pressed here, the character strings 164 to 168 are displayed on the basis of other music information within the management list 40. Meanwhile, if the F3 key 22c is pressed, the after download function is disabled. Besides, if the F1 key 22a is pressed, a download acceptance window shown in FIG. 17 is displayed on the liquid crystal display.

Displayed in the upper part of the download acceptance window is a character string 176 similar to the character string 162 in the top window of FIG. 16. Also, displayed under the character string 176 are character strings 178, 180 and 182 similar to the character strings 164, 166 and 168 that are displayed until immediately before the above mentioned F1 key 22a is pressed. Moreover, displayed under the character string 182 (or 180) is a horizontally written character string 184 for making an inquiry about whether or not to carry out downloading. Furthermore, displayed under the character string 184 are horizontally written character strings 186 and 188 in a horizontal row that indicate the respective functions of the F1 key 22a and F2 key 22b.

If the F2 key 22b is pressed here, display of the liquid crystal display 38 returns to the top window of FIG. 16. On the other hand, if the F1 key 22a is pressed, the music reproducing device 200 (the main CPU 16) operates as described below in order to download the data for storage on the music indicated by the character strings 178 and 180 from the music distribution server 400. Additionally, the operation of the music reproducing device 200 varies depending on whether the character string 182 is displayed or not, that is, whether either “1” or “0” is recorded or not in the section indicative of the present or absence of the data for storage on the music to be downloaded within the management list 40.

For example, if the character string 182 is displayed, that is, if the data for storage on the music for which the value “1” is recorded in the section of the presence or absence of data for storage within the management list 40 is to be downloaded, the music reproducing device 200 operates in the same manner as in the case where the F1 key 22a is pressed in the above mentioned download acceptance window of FIG. 9. More specifically, as shown in FIG. 15, it makes an access request and a download request for the data for storage to be downloaded, to the music distribution server 400. Then, in response to the download request, the data for storage on the music specified (by the data ID) is downloaded from the music distribution server 400 to the music reproducing device 200.

During the downloading, a message window similar to the above described one of FIG. 11 is displayed on the liquid crystal display 38 of the music reproducing device 200. Upon completion of the downloading, instead of the message window, a message window similar to the above described one of FIG. 12 is displayed on the liquid crystal display 38. Then, after a lapse of a certain time (three to five seconds), display of the liquid crystal display 38 returns to the top window of FIG. 16.

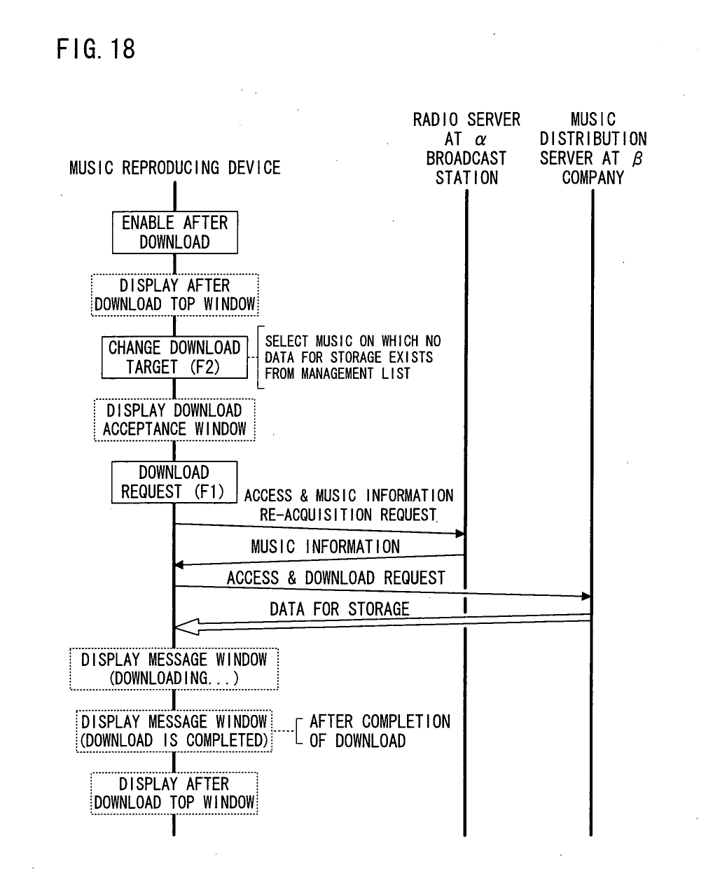

On the other hand, if the character string 182 is not displayed in the download acceptance window of FIG. 17, that is, if an operation of downloading the music for which “0” is recorded in the section indicative of the presence or absence of data for storage within the management list 40 is carried out, the music reproducing device 200 firstly makes an access request to the radio server 300 at the α broadcast station as shown in FIG. 18. Then, following the access request, the music reproducing device 200 issues a music information re-acquisition request to the radio server 300 at the α broadcast station in order to acquire again the music information on the music to be downloaded. In making the music information acquisition request, the music reproducing device 200 sends the music ID for the music to be downloaded to the radio server 300 at the α broadcast station. Also, it sends the above described operating environment information of FIG. 5 together with the music ID.

Upon reception of the music information re-acquisition request issued from the music reproducing device 200, the radio server 300 at the α broadcast station extracts the music information corresponding to the above mentioned music ID and according to the operating environment information from the management database 302, in the same manner as when receiving the music information acquisition request. Then, it sends the extracted music information to the music reproducing device 200 as shown in FIG. 18.

The music reproducing device 200 determines whether the data for storage on the music to be downloaded is prepared or not in the music distribution server 400, based on the music information acquired again from the radio server 300 at the α broadcast station, more specifically, based on whether or not either “1” or “0” is set in the section indicative of the presence or absence of data for storage within the music information. If the data for storage is prepared, that is, if it has been found that, although the data for storage was not prepared when the music information was acquired before, the data for storage has been prepared when the music information has been acquired again this time, the music reproducing device 200 updates (overwrites) the old music information recorded in the management list 40 with the music information acquired again this time. Then, as shown in FIG. 18, the data for storage on the desired music is downloaded from the music distribution server 400 in the same manner as shown in FIG. 15.

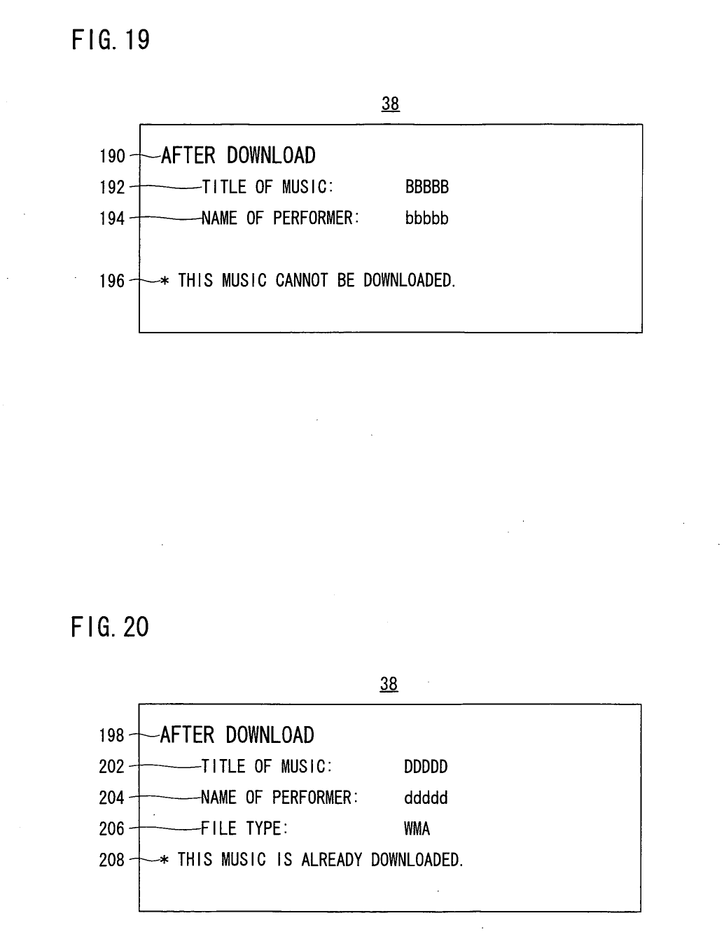

On the other hand, if it has been found from the music information acquired again this time that the data for storage on the music to be downloaded has not been yet prepared, a message window as shown in FIG. 19 is displayed on the liquid crystal display 38 of the music reproducing device 400. According to the message window, displayed in its upper part is a character string 190 similar to the display character string 162 in the top window of FIG. 16. Also, displayed under the character string 190 are character strings 192, 194 and 196 similar to the above mentioned character strings 146, 148 and 150 in the message window of FIG. 13. This message window is displayed for a certain time (about three to five seconds), and then the top window of FIG. 16 is displayed on the liquid crystal display 38.

Besides, if the data for storage on the music to be downloaded (indicated by the character strings 178, 180 and 182) in the download acceptance window of FIG. 17 is already downloaded and the F1 key 22a is pressed under that condition, a message window as shown in FIG. 20 is displayed on the liquid crystal display 38. Displayed in the upper part of the message window is a character string 198 similar to the character string 162 in the top window of FIG. 16. Also, displayed under the character string 198 are character strings 200, 202, 204 and 206 that are similar to the character strings 154, 156, 158 and 160 in the above mentioned message window of FIG. 14. As with the message window of FIG. 19, this message window is displayed for a certain time, and then the top window of FIG. 16 is displayed on the liquid crystal display 38.

The data for storage downloaded in this manner by means of the quick download function or the after download function can be reproduced by manipulating the operating key 22.

More specifically, when an operation of reproducing arbitrary data for storage is performed by means of the operating key 22, the sub CPU 20 notifies the main CPU 16 of the details of the operation. Based on the notification from the sub CPU 20, the main CPU 16 reads out the data for storage specified by the flash memory 42 in sequence by a predetermined amount and temporarily stores the read data for storage in the SDRAM 24. The data for storage stored in the SDRAM 24 is transferred in sequence to the DSP 18 under control of the main CPU 20. The DSP 18 decodes the transferred data for storage in the compression mode of the transferred data for storage (MP3 mode or MWA mode).

The PCM data generated by the decoding process is input into the D/A conversion circuit 28 and converted there into an audio signal as an analog electric signal. Then, the converted audio signal is input into the speaker 34 and 36 via the sound source switching circuit 30 and the amplifying circuit 32. This allows the music (sounds) corresponding to the downloaded data for storage to be output from the speakers 34 and 36.

Additionally, the music reproducing device 200 is also equipped with a CD (Compact Disc) player 44 and an AM/FM tuner 46. By manipulating the operating key 22, it is possible to reproduce the music (sounds) with either the CD player 44 or the AM/FM tuner 46 as a sound source.

More specifically, when an operation of determining either the CD player 44 or the AM/FM tuner 46 as a sound source is carried out by means of the operating key 22, the sub CPU 20 controls the sound source switching circuit 30 in such a manner that an analog audio signal output from the sound source side is input into the amplifying circuit 32. This allows the music with either the CD player 58 or the AM/FM tuner 60 as a sound source to be output and reproduced through the speakers 34 and 36.

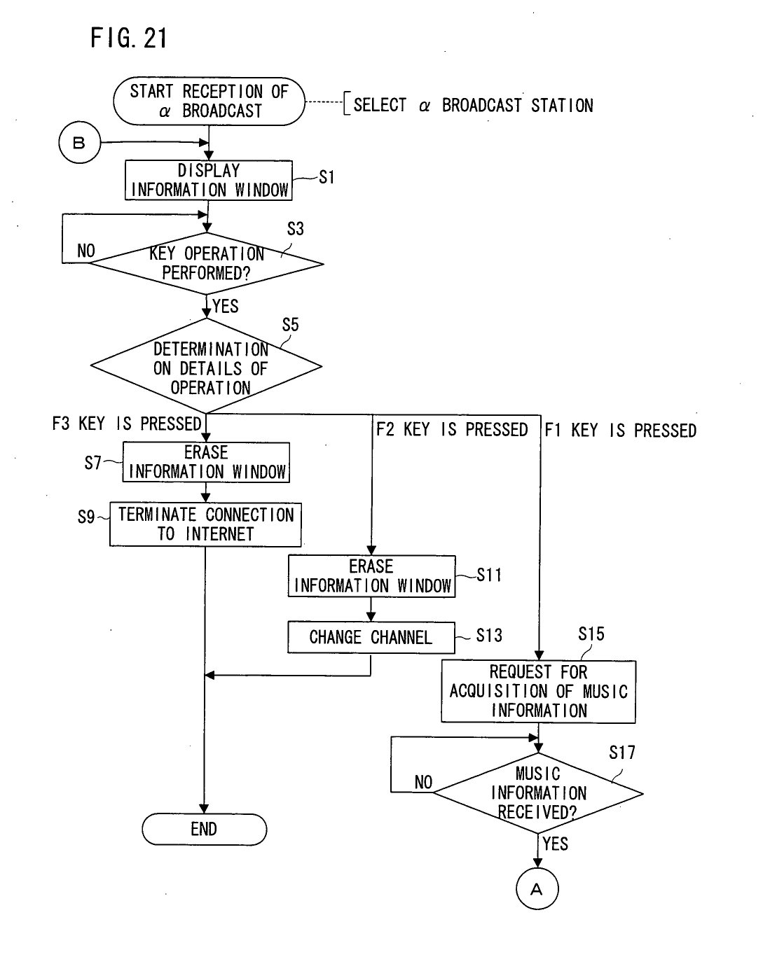

In order to implement the above described quick download function, the main CPU 16 carries out the processes represented by a flowchart of FIG. 21 to FIG. 23 according to a control program recorded in the flash memory 26.

More specifically, when it selects the α broadcast station by means of its function as an Internet radio receiver described above, the main CPU 16 goes to a step S1 of FIG. 21 to display the information window of FIG. 4 (in the strict sense, it instructs the sub CPU 20 to display the information window) on the liquid crystal display 38. Then, it waits until some operation is carried out by means of the operating key 22 in a step S3, more specifically, until the F1 key 22a, the F2 key 22b or the F3 key 22c is pressed.

When one of these keys has been pressed, the main CPU 16 moves to a step S5 to determine which key has been pressed.

If it has determined here that the F3 key 22c has been pressed, the main CPU 16 moves to a step S7 to stop the display of the information window of FIG. 4. Then, it terminates the connection to the Internet 100 in a step S9 in order to disable the function as an Internet radio receiver, and terminates a series of the processes shown in the flowchart.

On the other hand, if the F2 key 22b is pressed in the step S5, the main CPU 16 proceeds to a step S11 to stop the display of the information window of FIG. 4. Then, in the step S13, it selects another broadcast station (channel) and terminates the series of the processes shown in this flowchart.

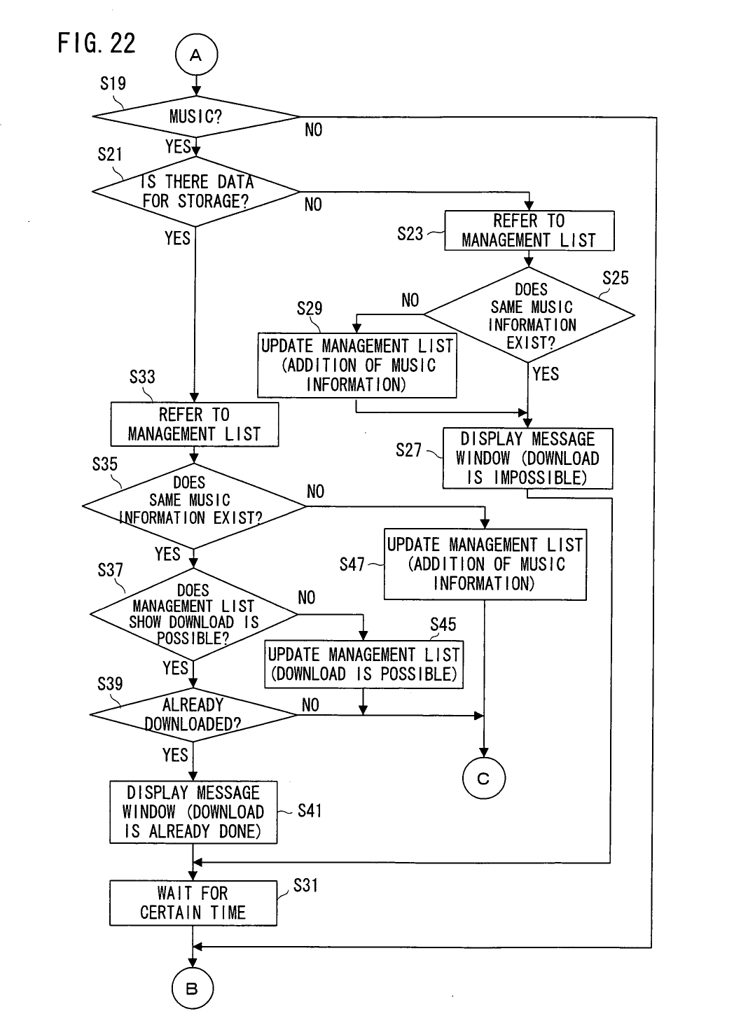

If the F1 key 22a is pressed in the step S5, the main CPU 16 moves to a step S15 to issue a music information acquisition request to the radio server 300 at the α broadcast station. Then, in a step S17, it waits for the music information to be sent from the radio server 300 at the α broadcast station in response to the music information acquisition request. Then, upon reception of the music information, it proceeds to a step S19 shown in FIG. 22.

In the step S19, the main CPU 16 determines whether the received music information relates to a piece of music or not, in other words, whether the information is a dummy or not. The determination on whether the information is a dummy or not depends on whether the music ID is set to the above described value “000000”.

If the received music information is a dummy, the main CPU 16 returns to the step S1 of FIG. 21. On the other hand, if the received music information is not a dummy but relates to a piece of music, it moves from the step S19 to a step S21 to determine from the received music information whether the data for storage is prepared or not in the music distribution server 400. This determination is made depending on which of the values “1” and “0” is set in the section indicative of the presence or absence of data for storage in

If it determined in the step S21 that no data for storage is prepared, the main CPU 16 proceeds to a step S23 to refer to the management list 40. Then, it determines in a step S25 whether or not there exists the same music information as the one received this time within the management list 40. This determination is made on the basis of the music ID.

Then, if it determined in the step S25 that there exists the same music information, the main CPU 16 proceeds to a step S27 to display the message window of FIG. 13 on the liquid crystal display 38. On the other hand, if it determines in the step S25 that the same music information does not exist, the main CPU 16 records the music information received this time in the management list 40 in the step S29, and then proceeds to the step S27.

After displaying the message window of FIG. 13 in the step S27, the main CPU 16 n [symbol] s to a step S31 to wait until a certain time (about three to five seconds) passes. After the lapse of the certain time, it returns to the step S1 of FIG. 21 in order to display the information window of FIG. 4.

If it determined in the above stated step S21 that the data for storage is prepared, the main CPU 16 goes to a step S33 to refer to the management list 40. Then, it determines in a step S35 whether or not there exists the same music information as the one received this time within the management list 40. This determination is made on the basis of the music ID, as in the case of the step S25.

Then, if it determined in the step S35 that there exists the same music information, the main CPU 16 goes to the step S37 to determine whether or not the management list 40 shows that the data for storage on the music represented by the music information received this time is prepared, that is, whether or not “1” is recorded in the section indicative of the presence or absence of data for storage in the management list 40. Then, if it determined that the management list 40 shows that the data for storage is prepared, the main CPU 16 moves to a step S39 to determine whether or not the data for storage on the music ID is already downloaded, that is, whether or not “1” is recorded in the section indicative of the completion of downloading in the management list 40.

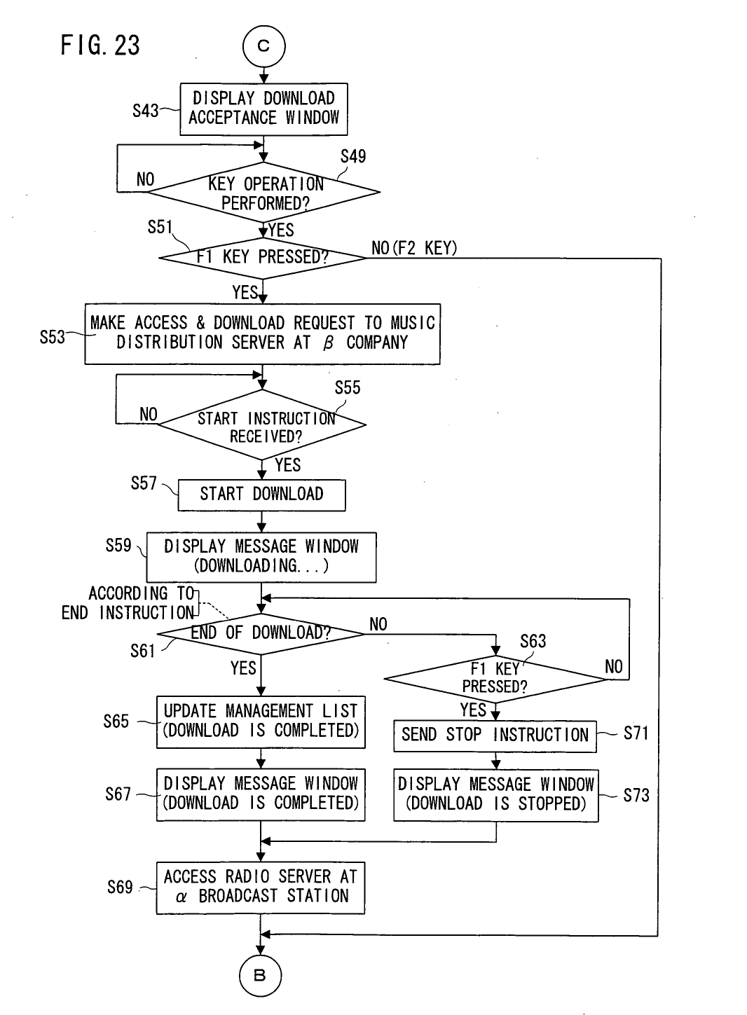

If the data for storage is already downloaded, the main CPU 16 goes to a step S41 to display the message window of FIG. 14 on the liquid crystal display 38. Then, it waits until a certain time passes in the step S31 and then returns to the step S1 of FIG. 21. On the other hand, if the data for storage is not yet downloaded, the main CPU 16 moves from the step S39 to a step S43 of FIG. 23.

In contrast to that, if it determined in the above mentioned step S37 that the management list 40 shows no preparation of the data for storage, the main CPU 16 proceeds to a step S45. Then, after updating the old music information recorded in the management list 40 with the music information newly received this time in the step S45, the main CPU 16 proceeds to the step S43 of FIG. 23.

Moreover, if it determined in the above mentioned step S35 that there exists no same music information as the one received this time within the management list 40, the main CPU 16 proceeds to a step S47. Then, after recording the music information received this time in the management list 40 in this step S47, it moves to the step S43 of FIG. 23.

In the step S43, the main CPU 16 displays the download acceptance window of FIG. 9 on the liquid crystal display 38. Then, in a step S49, it waits until any operation is performed by means of the operating key 22, more specifically, until the F1 key 22a or the F2 key 22b is pressed. When either key has been pressed, it proceeds to a step S51.

The main CPU 16 determines in the step S51 whether the F1 key 22a has been pressed or not in the above mentioned step S49. If the F2 key 22b was pressed here, not the F1 key 22a, it returns to the step S1 of FIG. 21. On the other hand, if the F1 key 22a was pressed, it moves to a step S53.

In the step S53, the main CPU 16 stops the access to the radio server 300 at the α broadcast station and issues an access request to the music distribution server 400. Then, in addition to the access request, it issues a download request for the data for storage corresponding to the music information received this time. In a step S55, it waits for the above stated start instruction to be sent from the music distribution server 400.

Upon reception of the start instruction in the step S55, the main CPU 16 goes to a step S57 to start downloading the data for storage from the music distribution server 400. Then, after displaying the message window of FIG. 11 on the liquid crystal display 38 in a step S59, it determines in a step S61 whether the downloading is completed or not, that is, whether the above mentioned end instruction is received from the music distribution server 400.

If it has determined here that the downloading is not completed, the main CPU 16 goes to a step S63 to determine whether the F1 key 22a has been pressed or not. Then, if it determined in the step S63 that the F1 key 22a has not been pressed, it returns to the step S61.

Then, if it determined in the step S61 that the downloading is completed by receiving the end instruction from the music distribution server 400, the main CPU 16 moves to a step S65 to record the completion of the downloading in the management list 40. That is, it records “1” in the section indicative of the completion of downloading within the management list 40. Then, after displaying the message of FIG. 12 on the liquid crystal display 38 in a step S67, it makes an access request to the radio server 300 at the α broadcast station in a step S69 and returns to the step S1 of the FIG. 21.

On the other hand, if the F1 key 22a is pressed in the above mentioned step S63, the main CPU 16 proceeds to a step S71 to send a stop instruction for stopping the downloading to the music distribution server 400 and stops the downloading. Then, after displaying a not illustrated message window indicative of the stoppage of the downloading on the liquid crystal display 38 in a step S73, it returns to the step S1 of FIG. 31 through the step S69.

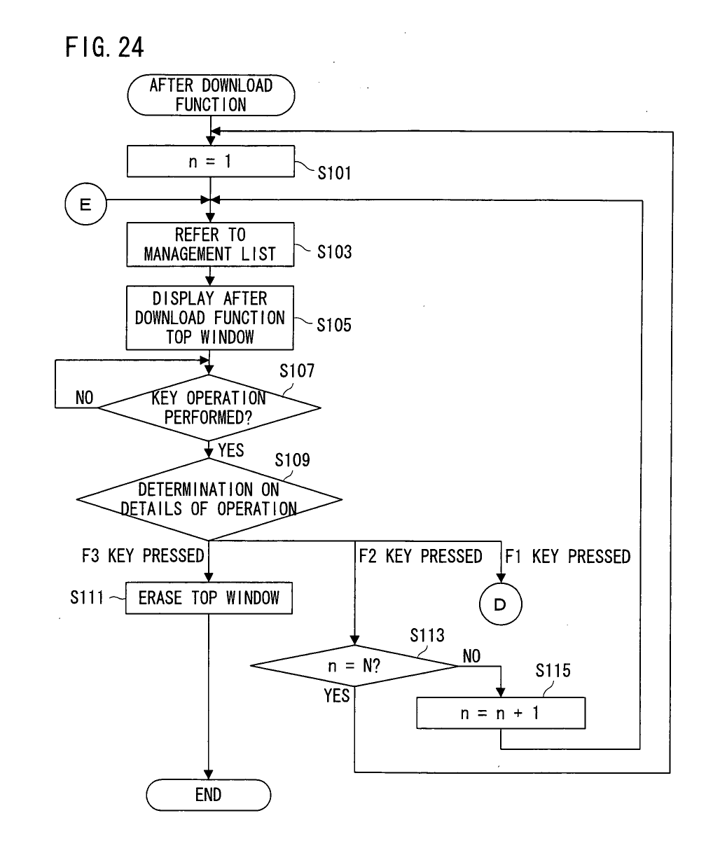

Meanwhile, in order to implement the above mentioned after download function, the main CPU 16 performs the processes shown in the flowchart of FIG. 24 to FIG. 26 according to the above mentioned control program.

More specifically, when the after download function is enabled by manipulating the operating key 22, the main CPU 16 goes to a step S101 of FIG. 24 to set the value “1” to an index (this is also indicated with a code n) for specifying the serial number “n” for the music information within the management list 40. Then, in a step S103, it refers to the management list 40 to recognize the music information specified by the index n. Then, based on the result of this recognition, the main CPU 16 displays the top window of FIG. 16 on the liquid crystal display 38.

After execution of a step S105, the main CPU 16 proceeds to a step S107 to wait until some operation is performed by means of the operating key 22, more specifically, until the F1 key 22a, the F2 key 22b or the F3 key 22c is pressed. Then, when any of these keys has been pressed, it goes to a step S109 to determine which key has been pressed.

If it has determined here that the F3 key 22c has been pressed, the main CPU 16 stops displaying the top window in a step S111 and terminates a series of the processes shown in this flowchart.

If it determined in the step S109 that the F2 key 22b has been pressed, the main CPU 16 goes to a step S113 to compare a value for the above mentioned index n with the maximum value “N” for the serial number “n”. If the two values are the same, it returns to the step S101. If the value for the index n is smaller than the maximum value “N” for the serial number “n”, it moves from the step S113 to a step S115 to increment the value for the index n by “1”. Then, the main CPU 16 returns to the step S103 to display the top window of FIG. 16 on the liquid crystal display 38 based on the music information specified by the index n after the increment.

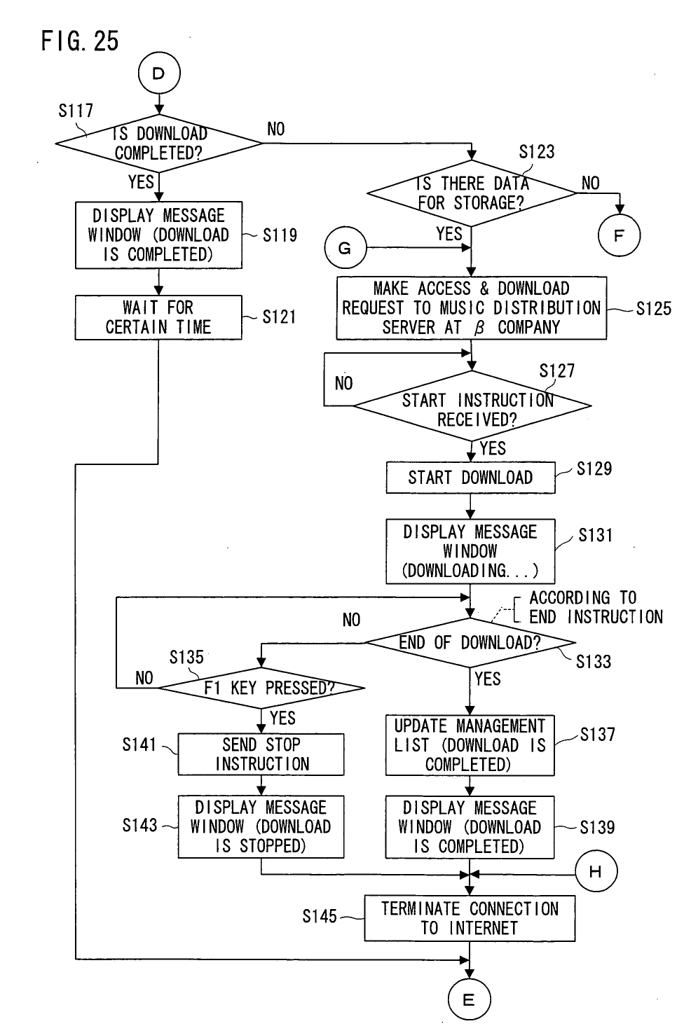

If it determined in the step S109 that the F1 key 22a has been pressed, the main CPU 16 goes to a step S117 of FIG. 25. Then, it determines in the step S117 whether the data for storage on the music currently displayed in the top window of FIG. 16 is already downloaded or not. This determination is made depending on whether “1” is recorded or not in the section indicative the completion of downloading within the management list 40.

If it determined in the step S117 that the data for storage is already downloaded, the main CPU 16 goes to a step S119 to display the message window of FIG. 20 on the liquid crystal display 38. Then, after waiting until a certain time (about three to five seconds) passes in a step S121, it returns to the step S103 of FIG. 24.

On the other hand, if it determined that the data for storage is not yet downloaded, the main CPU 16 moves to a step S123. Then, it determines whether or not the management list 40 shows that the data for storage on the music currently displayed in the top window of FIG. 16 is prepared, that is, whether or not “1” is recorded in the section indicative of the presence or absence of data for storage. If the data for storage is prepared, the main CPU 16 proceeds to a step S125.

The step S125 is the same process as that of the above stated step S53 shown in FIG. 23, and also steps S127 to S143 following the step S125 are the same processes as those of the steps S55 to S73 (except for the step S69) shown in FIG. 23. Therefore, a detailed description is not given as to these steps S125 to S143.

After execution of the step S139, or after execution of the step S143, the main

After execution of the step S139, or after execution of the step S143, the main CPU 16 moves to a step S145 to terminate the connection to the Internet 100. Then, after execution of the step S145, it returns to the step S103 of FIG. 24.

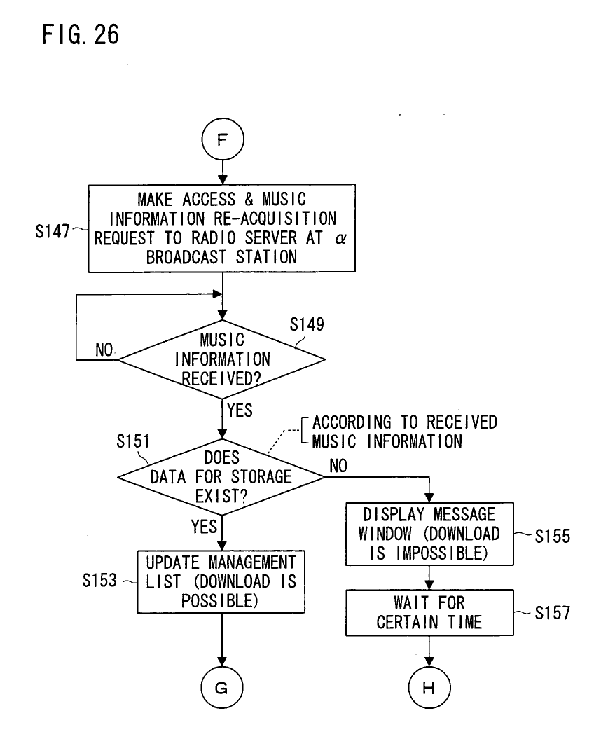

Additionally, if it determined in the above mentioned step S123 that the management list 40 shows no preparation of the data for storage, the main CPU 16 goes to a step S147 of FIG. 26. Then, in the step S147, it makes an access request to the radio server 300 at the α broadcast station and also makes a music information re-acquisition request for the music currently displayed in the top window shown in FIG. 16. Then, it waits for the music information to be sent from the radio server 300 at the α broadcast station in response to the music information re-acquisition request. Upon reception of the music information in a step S149, it proceeds to a step S151.

In the step S151, the main CPU 16 determines from the music information received in the above mentioned step S149 whether the data for storage is prepared or not. If the data for storage is prepared, the main CPU 16 moves to a step S153 to update the old music information recorded in the management list 40 with the new music information received in the step S149. Then, it goes to the step S125 of FIG. 25 to download the data for storage from the music distribution server 400 based on the new music information.

On the other hand, if it determined in the step S149 from the received music information that the data for storage is not yet prepared, the main CPU 16 moves from the step S151 to a step S155. Then, after displaying the message window of FIG. 19 on the liquid crystal display 38 in the step S155, it waits until a certain time (about three to five seconds) passes. After the lapse of the certain time, it returns to the step S103 of FIG. 24 through the step S145 of FIG. 25.

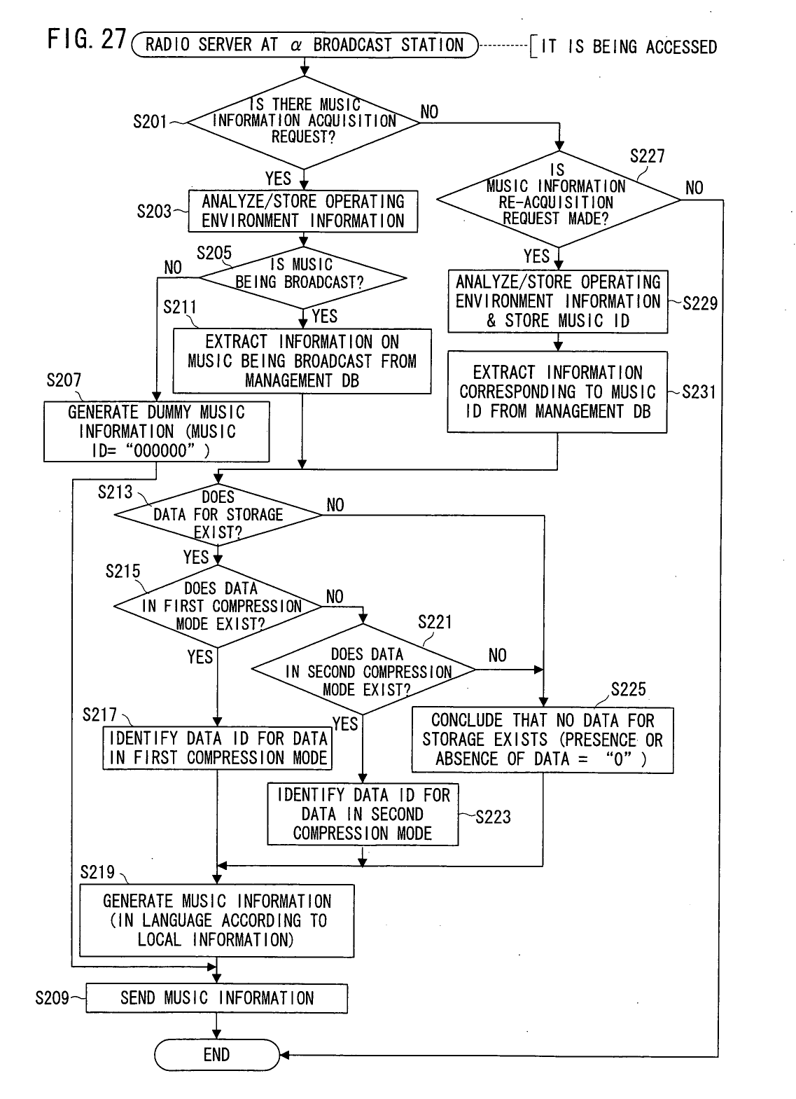

In response to the operation of the music reproducing device 200 (the main CPU 16), the radio server 300 at the α broadcast station performs the processes shown in the flowchart of FIG. 27 while it is accessed (selected) by the music reproducing device 200.

More specifically, the radio server 300 at the α broadcast station determines in the step S201 whether or not the music reproducing device 200 has issued a music information request. If it has determined here that the music information request has been issued, it proceeds to a step S203 to analyze the details of the operating environment information together with the music information acquisition request sent from the music reproducing device 200. Then, it stores a result of the analysis, that is, the first compression mode, the second compression mode and the local information in a not illustrated storage area contained in it.

Then, the radio server 300 determines in the step S205 whether a piece of music is currently broadcast or not. If a D.J.'s talk or a CM is broadcast, not a piece of music, the radio server 300 proceeds to a step S207 to generate the above stated dummy music information. In a step S209, it sends the generated dummy music information to the music reproducing device 200 as an accessing source, and temporarily terminates a series of the processes shown in FIG. 27.

On the other hand, if a piece of music is currently broadcast, the radio server 300 moves from the step S205 to a step S211 to extract the information on the music being broadcast from the management database 302. Then, in a step S213, it determines from a result of the extraction in the step S211 whether data for storage on the music being broadcast is prepared or not in the music distribution server 400.

If the data for storage is prepared here, the radio server 300 further determines in a step S215 whether data for storage compressed in the above stated first compression mode is prepared or not. Then, if the data for storage compressed in the compression mode is prepared, a data ID for the data for storage is identified in a step S217. Then, in a step S219, the radio server 300 generates the music information shown in FIG. 5, based on the data ID identified in the step S217 and the result of the extraction in the above mentioned step S211. Incidentally, as for the title of the music and the name of the performer among the music information, information for expressing these items in the above stated local information is prepared.

Then, the radio server 300 sends the music information generated in the step S219 to the music reproducing device 200 in a step 209.

On the other hand, if it determined in the above stated step S215 that no data for storage compressed in the first compression mode is prepared, the radio server 300 goes to the step S221 to determine whether the data for storage compressed in the above stated second compression mode is prepared or not. Then, if the data for storage compressed in such a compression mode is prepared, the radio server 300 moves to a step S223 to identify the data ID for the data for storage, and then proceeds to a step S219.

Additionally, if it determined in the step S221 that no data for storage compressed in the second compression mode is prepared, the radio server 300 proceeds to a step S225. Then it comes to conclusion in the step S225 that there is no data for storage, and generates music information based on this result in the step S219. Also, if it determined that no data for storage is prepared in the above described step S213, the radio server 300 proceeds to the step S219 through the step S225.

Then, if it determined in the above mentioned step S201 that the music reproducing device 200 has not issued a music information acquisition request, the radio server 300 goes to a step S227 to determine whether or not the music reproducing device 200 has issued a music information re-acquisition request. If it determined here that the music information re-acquisition request has been issued, the radio server 300 moves to a step S229 to analyze the details of the operating environment information sent together with the music information re-acquisition request. Then, the radio server 300 stores a result of the analysis in the above mentioned storage area. Additionally, the radio server 300 sends a music ID together with the operating environment information, and the music ID is also stored in the storage area.

Then, in a step S231, the radio server 300 extracts information on the music ID stored in the storage area in the step S229 from the management database 302. Then, after performing the step S23 1, it proceeds to the step S213.

Also, if it determined in the step S227 that the music reproducing device 200 did not issue a music information re-acquisition request, the radio server 300 terminates the series of the processes shown in the flowchart of FIG. 27.

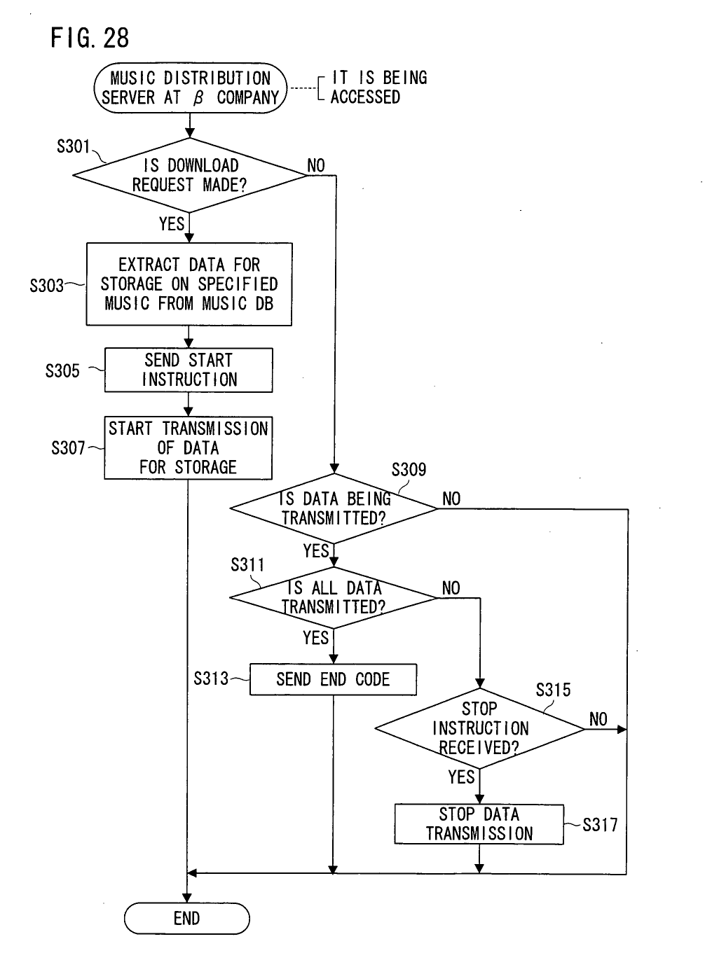

Additionally, the music distribution server 400 managed by the β company performs the processes shown in the flowchart of FIG. 28 while it is accessed by the music reproducing device 200.

More specifically, the music distribution server 400 determines in a step S301 whether the music reproducing device 200 has issued a download request or not. If it has determined here that the download request has been issued, the music distribution server 400 goes to a step S303 to extract data for storage on the music specified by the download request (data ID) from the music database 402. Then, after sending the above mentioned start instruction to the music reproducing device 200 as an accessing source in a step S305, it starts transmission of the data for storage extracted in the step S303 to the music reproducing device 200 in a step S307. After performing the step S307, the music distribution server 400 temporarily terminates a series of the processes shown in the flowchart of FIG. 28.

On the other hand, if it determined in the step S301 that the music reproducing device 200 did not issue a download request, the music distribution server 400 proceeds to a step S309. Then, it determines in the step S309 whether or not the data for storage is currently being transmitted to the music reproducing device 200. If the data is not being transmitted, the music distribution server 400 directly terminates the series of the processes shown in this flowchart. If the data is being transmitted, the music distribution server 400 proceeds to a step S311 to determine whether the data for storage has been completely transmitted or not. Then, if the data for storage has been completely transmitted, the music distribution server 400 sends the above mentioned end instruction to the music reproducing device 200 to terminate the series of the processes in a step S313.

If it determined in the step S311 that the data for storage is not completely transmitted, the music distribution server 400 further goes to a step S315 to determine whether or not the music reproducing device 200 has sent the above mentioned stop instruction. If it has received the stop instruction, the music distribution server 400 stops transmitting the data for storage in a step S317 to terminate the series of the processes shown in this flowchart. On the other hand, if it has not received the stop instruction, the music distribution server 400 directly terminates the series of the processes.

As understood from the above description, according to the quick download function of the music reproducing device 200 in this embodiment, when arbitrary music is being broadcast at a program from the α broadcast station, the user can promptly download data for storage on the music from the music distribution server 400 by just performing a simple operation of pressing the F1 key 22a twice. Also, the data is provided in a compression mode capable of being decoded by the music reproducing device 200. That is, this function makes it possible to download the data for storage on desired music in an easy manner and in a form according to the operating environment of the music reproducing device 200.

In addition, according to the after download function, the user can select a piece of music to be downloaded by pressing the F2 key 22b. After deciding the music to be downloaded, he can download data for storage on the music from the music distribution server 400 by just performing a simple operation of pressing the F1 key 22a twice. Also, in this case as well, the data to be downloaded is provided in the compression mode capable of being decoded by the music reproducing device 200. Therefore, the after download function also makes it possible to download the data for storage in an easy manner and in a form according to the operating environment of the music reproducing device 200.

Besides, employed in this embodiment are one radio server 300 and one music distribution server 400 which constitute the music distribution system 10, for the sake of simplified description. Alternatively, pluralities of these servers may be provided. In this case, it is necessary to incorporate URL (Uniform Resource Locator) information for designating the music distribution server 400 as a download request destination into the music information transmitted from the radio server 300 to the music distribution device 200.

In addition, among the information recorded in the management database 302 of the radio server 300, only the music information according to the operating environment of the music reproducing device 200 are here transmitted to the music reproducing device 200. However, the information transmitted to the music reproducing device 200 is not limited to the music information. For example, all the music information on an arbitrary piece of music may be transmitted from the radio server 300 to the music reproducing device 200. Also, the music reproducing device 200 may extract information according to its operating environment from among the acquired music information later and then download the data for storage from the music distribution server 400 based on the extracted information.

Also, in this embodiment, the compression modes supported by the music reproducing device 200 are limited to the MP3 mode and the WMA mode. Alternatively, other compression modes may be supported.

Besides, the operating environment information transmitted from the music reproducing device 200 to the radio server 300 includes the first compression mode, the second compression mode and the local information. As an alternative, it includes other information. For example, such information as the model name, serial number and manufacturing date of the music reproducing device 200 may be incorporated into the operating environment information.

Moreover, the means to connect the music reproducing device 200 to the Internet 100 are not limited to the wired ones and may be wireless ones.

Furthermore, in this embodiment, a description is given as to the case where music, an audio content, is handled. The present invention is also applicable to the case where visual contents such as images are handled. A fee may be charged or not for these contents.

Although the present invention has been described and illustrated in detail, it is clearly understood that the same is by way of illustration and example only and is not to be taken by way of limitation, the spirit and scope of the present invention being limited only by the terms of the appended claims.

1: A content capturing device having a function of reproducing in real time a first content signal received from a first sending source, comprising:
a holder for holding an operating environment information;
an acquirer for acquiring content information corresponding to the first content signal and according to the operating environment information from said first sending source; and
a capturer for capturing a second content signal for storage from a second sending source based on the content information.

2: A content capturing device according to claim 1, wherein said acquirer includes a requester for issuing a request to said first sending source for acquisition of the content information, and a receiver for receiving the content information sent from said first sending source in response to the request made by said requester.

3: A content capturing device according to claim 2, wherein said requester delivers the operating environment information in making a request to said first sending source for acquisition of the content information.

4: A content capturing device according to claim 1, wherein the second content signal is a compressed signal, further comprising a decompressor for decompressing the second content signal which is compressed, and wherein the operating environment information includes compression mode information on compression modes supported by said decompressor.

5: A content capturing device according to claim 1, wherein the operating environment information includes language information indicative of a specific language, and further comprising an information outputter for outputting at least a part of said content information in said specific language.

6: A content capturing device according to claim 1, further comprising a setter for arbitrarily setting the operating environment information.

7: A content capturing device according to claim 1, wherein the first content signal is an audio signal for radio broadcasting.

8: A content capturing method with a function of reproducing in real time a first content signal received from a first sending source, comprising steps of:
a holding step of holding an operating environment information;
an acquiring step of acquiring content information corresponding to the first content signal and according to the operating environment information from said first sending source; and
a capturing step of capturing a second content signal for storage from a second sending source based on the content information.
